(19) United States
(12) Patent Application Publication
(10) Pub. No.: US 2026/0208456 A1
(43) Pub. Date: Jul. 23, 2026

(54) POST-PROCESSING SYSTEM AND PROCESS FOR 3D-PRINTED PLASTIC PARTS

(71) Applicant: Suzhou REPOLY Technology Co., Ltd, Suzhou (CN)

(72) Inventors: Lu Cui, Suzhou (CN); Junjian Ye, Suzhou (CN); Zhe Xue, Suzhou (CN)

(21) Appl. No.: 19/446,839

(22) Filed: Jan. 12, 2026

(30) Foreign Application Priority Data
Jan. 23, 2025 (CN) 202510105617.8

(51) Int. Cl. B29C 71/00; B29C 64/379; B33Y 40/20

(52) U.S. Cl. CPC B29C 71/0009; B29C 64/379; B33Y 40/20; B29C 2071/0027

(57) ABSTRACT

A post-processing system and a processing method for 3D-printed plastic parts are disclosed. The post-processing system comprises a solvent storage bottle, a part processing assembly, and a solvent recovery assembly. The solvent storage bottle is configured to store a solvent. The part processing assembly is configured to perform vapor polishing on 3D-printed plastic parts. The solvent recovery assembly is configured to recover solvent vapor generated in the part processing assembly and to re-liquefy and store the recovered solvent. An output end of the solvent storage bottle is fluidly connected to an input end of a solvent chamber of the part processing assembly through a peristaltic pump, and the part processing assembly is fluidly connected to the solvent recovery assembly through a recovery valve.

### TECHNICAL FIELD

The present disclosure relates to post-processing of additively manufactured plastic parts, and more particularly to a post-processing system and a processing method for improving surface quality of 3D-printed plastic parts using solvent vapor treatment and solvent recovery.

### BACKGROUND

Compared with photopolymer resin printing technologies that currently have a relatively high market share, powder bed fusion (PBF) and fused deposition modeling (FDM) technologies have shown increasing competitiveness and importance in both consumer and industrial fields due to improved part performance, higher design freedom for complex structures, and environmentally favorable material characteristics. Representative applications include, for example, high-end customized eyewear frames, medical supports, customized robot parts, rehabilitation assistive devices, automotive components, and wearable consumer products. However, due to inherent process characteristics, plastic parts produced by PBF and FDM commonly exhibit surface defects after printing, such as high surface roughness, residual powder, and visible layer lines. These defects are unacceptable for products requiring high appearance quality. Accordingly, post-processing polishing is generally required.

Post-processing approaches for 3D-printed plastic parts may generally be categorized as physical methods and chemical methods. In one physical approach, non-metallic microbeads of selected particle sizes may be used for surface blasting. While blasting may reduce surface roughness, it may also damage fine features and is often insufficient to achieve a smooth surface for either rigid plastics or elastomers.

In chemical approaches, organic solvents having good affinity for the plastic may be used to treat the surface via immersion or vapor exposure. Immersion processes, however, are often difficult to control in mass production, and may produce defects due to geometry-dependent effects and the lack of specialized equipment. In addition, immersion workflows may involve complex operations and solvent exposure that can raise environmental and personnel safety concerns.

Vapor treatment processes generally provide more uniform surface treatment. Existing commercial equipment for vapor post-processing of 3D-printed plastic parts typically places parts in a sealed chamber and introduces solvent vapor to surround the parts. Solvent vapor may condense on the part surfaces, slightly dissolve the surface, and promote flow and leveling to fill surface irregularities, thereby improving surface finish. Such equipment is comparatively easier to control and may reduce contamination relative to immersion processes. Nevertheless, conventional vapor-based systems can be limited by vapor and/or droplet delivery paths, temperature control systems, circulation and reflux configurations, and condensation/solidification mechanisms.

For example, certain flash-evaporation-based vapor generation systems may experience temperature gradients and large chamber temperature fluctuations that can lead to localized over-softening, peeling, or surface defects; condensation at the chamber top may cause white spots and drip marks; airflow duct structures may create localized overheating and part deformation; and large temperature differences between a condenser and a chamber may lead to orange-peel texture. In systems using atomization combined with evaporation, overly sensitive temperature control may cause insufficient leveling or over-processing, resulting in deformation and collapse of parts, and fully closed-loop condensation control may introduce haze or frost-like patterns. For complex and fine structures, conventional hot-vapor delivery may fail to provide sufficient solvent vapor access to certain regions, leading to non-uniform treatment and/or deformation.

With the expansion of the 3D-printed consumer product market, higher requirements are imposed on post-processing equipment and processes for diverse and complex parts in mass production. While printing equipment continues to improve, post-processing equipment and related processes have been comparatively less developed, and existing approaches may lack deep investigation of correlations among process parameters and resulting part properties. As a result, multiple processing cycles, poor material-process matching, high solvent residue requiring secondary drying, and other issues may occur.

Accordingly, there remains a need for improved post-processing system architectures and process parameter control that provide enhanced economy, scientific controllability, and processing efficiency.

### SUMMARY

The present disclosure provides a post-processing system for 3D-printed plastic parts and a processing method thereof.

In one aspect, a post-processing system is provided, comprising a solvent storage bottle (1), a part processing assembly (2), and a solvent recovery assembly (3). The solvent storage bottle (1) stores a solvent. The part processing assembly (2) is configured to perform vapor polishing on 3D-printed plastic parts. The solvent recovery assembly (3) is configured to recover solvent vapor generated in the part processing assembly (2) and to re-liquefy and store the recovered solvent.

An output end of the solvent storage bottle (1) is fluidly connected to an input end of a solvent chamber (206) of the part processing assembly (2) through a peristaltic pump (4). The part processing assembly (2) is fluidly connected to the solvent recovery assembly (3) through a recovery valve (5).

In some embodiments, the part processing assembly (2) comprises a reaction chamber (201). A hanger (202) configured to suspend 3D-printed plastic parts is arranged inside the reaction chamber (201). A first vacuum pump (203) is connected to the reaction chamber (201) and is configured to adjust gas pressure within the reaction chamber (201). An input end of the reaction chamber (201) is fluidly connected to an output end of the solvent chamber (206) through a pressurizing valve (205).

In some embodiments, a heating element (204) is arranged at the reaction chamber (201), and includes a heater configured to heat the reaction chamber (201) for drying operations.

In some embodiments, the solvent recovery assembly (3) comprises a recovery chamber (301) having an air bag (302) disposed therein, and an air inlet valve (303) and an exhaust valve (304) arranged outside the recovery chamber (301) to control pressure of the air bag (302). An output end of the recovery chamber (301) is fluidly connected to a condenser tube (306) through a condensing valve (305), and an output end of the condenser tube (306) is connected to a recovery bottle (307). In some embodiments, a second vacuum pump (308) is arranged at the recovery chamber (301) to adjust pressure within the recovery chamber (301).

In another aspect, a processing method based on the post-processing system is provided, including: installing parts on a detachable hanger (202) and sealing the reaction chamber (201); setting process parameters including solvent type, solvent amount, vacuum pressure, pressure holding time, drying temperature and time, and circulating air temperature; evacuating the reaction chamber (201) using the first vacuum pump (203); opening the pressurizing valve (205) to rapidly reduce pressure in the solvent chamber (206) and vaporize solvent, thereby filling the reaction chamber (201) with solvent vapor and surrounding the parts; closing the pressurizing valve (205) to allow solvent vapor to condense on part surfaces to form a liquid layer and holding pressure for a predetermined period; drying the parts using the heating element (204); and recovering solvent vapor by transferring vapor to the recovery chamber (301) under pressure differential and condensing the vapor into liquid collected in the recovery bottle (307), optionally in one or more recovery cycles.

### Advantages and Technical Effects

In some embodiments, the disclosed system and method utilize rapid diffusion of gas molecules during vacuum-to-pressure equalization. By rapidly connecting a solvent chamber (206) at approximately ambient pressure to a reaction chamber (201) under vacuum, solvent in the solvent chamber (206) may undergo rapid boiling and vaporization due to sudden pressure drop, and solvent vapor may be introduced into the reaction chamber (201) through the pressurizing valve (205). The solvent vapor can rapidly and uniformly reach surfaces of parts suspended on the hanger (202), including regions that may otherwise be difficult to access, and then condense on the part surfaces to form a liquid layer.

Surface defects may be gradually dissolved and leveled under the action of the solvent. As pressure in the reaction chamber (201) rises, once chamber pressure exceeds a saturated vapor pressure threshold of the solvent, remaining liquid solvent may cease further evaporation, which can reduce risks of over-processing, excessive solvent contact, and material softening or collapse. After a predetermined holding period, vapor polishing is completed, followed by drying and solvent recovery. In some embodiments, treated parts exhibit improved surface uniformity with reduced residual solvent and reduced odor.

In some embodiments, process inputs may include material type, part weight, density, and other characteristics, which may be used to determine solvent amount and associated process parameters to achieve controlled surface treatment, reduce solvent waste, and improve processing efficiency. In some embodiments, solvent is metered from the solvent storage bottle (1) into the solvent chamber (206) via the peristaltic pump (4) prior to each cycle, which can reduce manual solvent handling and solvent vapor exposure.

In some embodiments, the recovery approach uses pressurized condensation. Solvent vapor transferred from the reaction chamber (201) to the recovery chamber (301) can be compressed by inflating the air bag (302) to reduce effective chamber volume and raise vapor pressure, and then passed through the condenser tube (306) to condense and collect liquid solvent in the recovery bottle (307), enabling solvent reuse and improved safety and environmental performance.

In some embodiments, an upper-opening door configuration and a lifting steel hanger (202) facilitate part loading and unloading for different part sizes.

### BRIEF DESCRIPTION OF THE DRAWINGS

FIG. 1 is a schematic diagram of a system flow of an embodiment of the present invention.

FIG. 2 is a schematic diagram of a system device structure of an embodiment of the present invention.

FIG. 3 shows scanning electron microscope (SEM) images of PA12 part surfaces before and after surface smoothing treatment in an embodiment of the present invention.

FIG. 4 shows SEM images of PA11 part surfaces before and after surface smoothing treatment in an embodiment of the present invention.

FIG. 5 shows SEM images of PEBAX part surfaces before and after surface smoothing treatment in an embodiment of the present invention.

FIG. 6 shows SEM images of TPA part surfaces before and after surface smoothing treatment in an embodiment of the present invention.

FIG. 7 shows SEM images of PA12 parts after deep enhancement treatment in an embodiment of the present invention.

### REFERENCE NUMERALS

1, solvent storage bottle;
2, part processing assembly;
201, reaction chamber;
202, hanger;
203, first vacuum pump;
204, heating element;
205, pressurizing valve;
206, solvent chamber;
3, solvent recovery assembly;
301, recovery chamber;
302, air bag;
303, air inlet valve;
304, exhaust valve;
305, condensing valve;
306, condenser tube;
307, recovery bottle;
308, second vacuum pump;
4, peristaltic pump;
5, recovery valve.

### DETAILED DESCRIPTION OF EMBODIMENTS

To make the objectives, technical solutions, and advantages of the present disclosure more apparent, embodiments are described below with reference to the drawings.

Embodiments 1-4 relate to surface smoothing treatment of different materials. Embodiment 5 relates to deep enhancement treatment for the material in Embodiment 1. Embodiment 6 is a comparative example.

### Embodiment 1

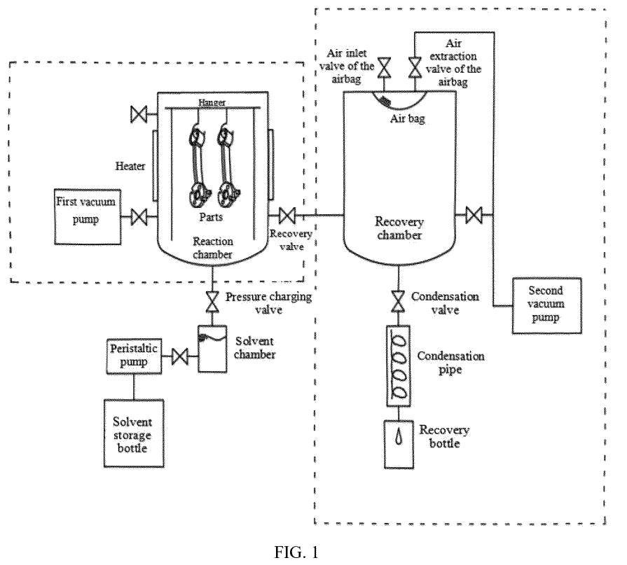

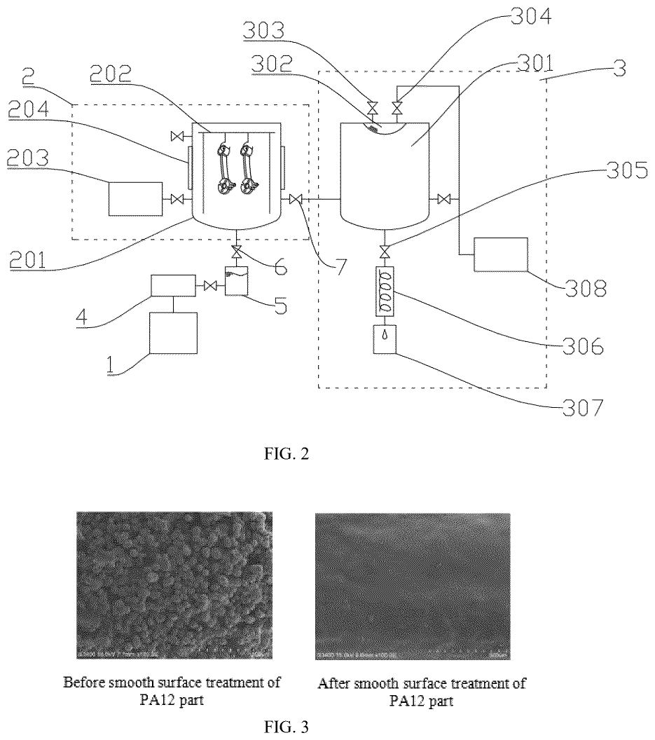

Referring to FIGS. 1-3, five groups each of PA12 standard tensile test specimens (GB/T 528-200), flexural test specimens (GB/T 9341-2008), and impact test specimens (GB/T 18743.1-2022) are weighed after printing and blasting, mounted on the hanger (202), and placed into the reaction chamber (201). After confirming that the 3D-printed plastic parts do not significantly move and do not contact each other, the reaction chamber (201) is sealed and an end cover is locked.

On a device interface, the material type is selected as PA12, a solid type is selected, a part weight is 38.6 g, a quantity is 15, and a processing objective is surface smoothing treatment. The solvent is hexafluoroisopropanol with a solvent amount of 15 mL, a vacuum pressure of 10 kPa, a holding time of 2 minutes, a drying temperature of 60° C. with a drying time of 30 minutes, a circulating air temperature of 55° C., and a recovery cycle count of 2.

After parameter setting, solvent in the solvent storage bottle (1) is delivered to the solvent chamber (206) through the peristaltic pump (4). The reaction chamber (201) is evacuated to 10 kPa using the first vacuum pump (203). The pressurizing valve (205) between the reaction chamber (201) and the solvent chamber (206) is opened such that the solvent chamber (206) rapidly reaches a vacuum state. Hexafluoroisopropanol undergoes brief boiling and rapid vaporization to form a solvent vapor environment that surrounds the PA12 parts. The pressurizing valve (205) is then closed, and solvent vapor condenses on the part surfaces to form a liquid layer, followed by pressure holding for the predetermined period. The PA12 surfaces are mildly dissolved and leveled to achieve a smoothing effect.

The heater is activated to dry the parts in the reaction chamber (201). The second vacuum pump (308) is activated to evacuate the recovery chamber (301) and the air bag (302) to below 0.1 kPa, with the exhaust valve (304) open and the air inlet valve (303) closed. The second vacuum pump (308) is then closed and the recovery valve (5) is opened, causing solvent vapor in the reaction chamber (201) to rapidly enter the recovery chamber (301) under pressure differential, while liquid solvent on part surfaces accelerates evaporation. The recovery valve (5) and the exhaust valve (304) are closed, and the air inlet valve (303) and the condensing valve (305) are opened, such that the expanded air bag (302) rapidly compresses and increases pressure to approximately atmospheric pressure, thereby pushing high-concentration solvent vapor into the condenser tube (306), where the vapor condenses into liquid droplets and is collected in the recovery bottle (307). The condensing valve (305) and the air inlet valve (303) are closed, and the exhaust valve (304) and the second vacuum pump (308) are opened to evacuate the recovery chamber (301) and the air bag (302) to below 0.1 kPa to enter a next recovery cycle. After two recovery cycles, the reaction chamber (201) is vented to atmosphere, the end cover is opened, and the parts are removed.

Surface observation, weighing, and mechanical performance tests are performed according to the corresponding standards.

### Embodiment 2

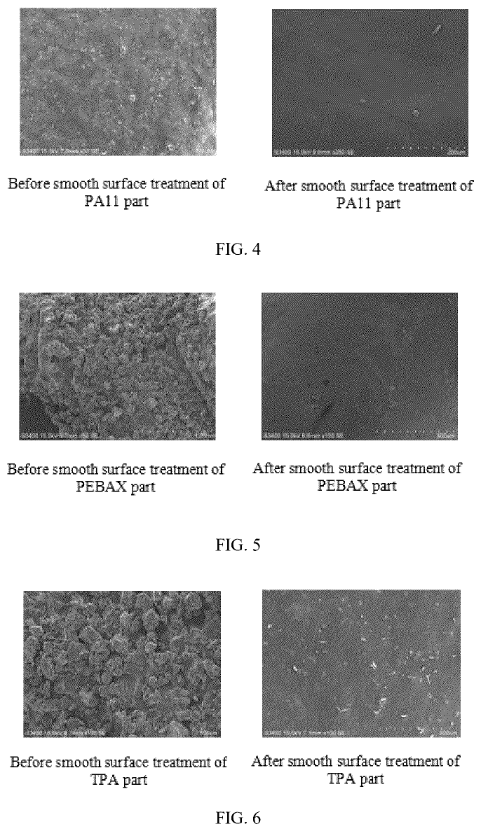

Referring to FIGS. 1-2 and 4, Embodiment 2 differs from Embodiment 1 in that the material is PA11, the parts are of a solid type, a part weight is 39.6 g, and the processing objective is surface smoothing treatment. Corresponding process parameters are: hexafluoroisopropanol as solvent, 21 mL solvent amount, 8 kPa vacuum pressure, 4 minutes holding time, 60° C. drying temperature with 30 minutes drying time, 55° C. circulating air temperature, and 2 recovery cycles.

### Embodiment 3

Referring to FIGS. 1-2 and 5, Embodiment 3 differs from Embodiment 1 in that the material is PEBAX, the parts are of a solid type, a part weight is 39.6 g, a quantity is 15, and the processing objective is surface smoothing treatment. Corresponding process parameters are: a mixed solvent of hexafluoroisopropanol and chloroform (3:1), 18 mL solvent amount, 15 kPa vacuum pressure, 2 minutes holding time, 60° C. drying temperature with 30 minutes drying time, 55° C. circulating air temperature, and 4 recovery cycles.

### Embodiment 4

Referring to FIGS. 1-2 and 6, Embodiment 4 differs from Embodiment 1 in that the material is TPA, the parts are lattice parts, a part weight is 210 g, a quantity is 2, and the processing objective is surface smoothing treatment. Corresponding process parameters are: a mixed solvent of hexafluoroisopropanol and methanol (5:1), 18 mL solvent amount, 15 kPa vacuum pressure, 2 minutes holding time, 60° C. drying temperature with 30 minutes drying time, 55° C. circulating air temperature, and 4 recovery cycles.

### Embodiment 5

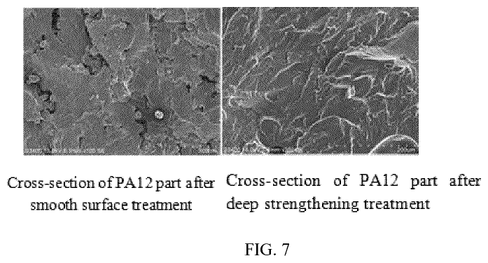

Referring to FIGS. 1-2 and 7, Embodiment 5 differs from Embodiment 1 in that the material is PA12, the parts are of a solid type, a part weight is 38.6 g, a quantity is 15, and the processing objective is deep enhancement treatment. Corresponding process parameters are: hexafluoroisopropanol as solvent, 20 mL solvent amount, 5 kPa vacuum pressure, 5 minutes holding time, 60° C. drying temperature with 30 minutes drying time, 55° C. circulating air temperature, and 2 recovery cycles.

### Embodiment 6 (Comparative Example)

Embodiment 6 compares processing data of the 3D-printed plastic parts after treatment in Embodiments 1-4 with corresponding data before treatment, as shown in Table 1, and compares data after treatment in Embodiment 5 with corresponding data after treatment in Embodiment 1, as shown in Table 2.

TABLE 1
Comparison of mechanical properties before and after
surface smooth treatment for different materials

| | Item | | | | | | | |
|---|---|---|---|---|---|---|---|---|
| | PA12 | | PA11 | | PEBAX | | TPA | |
| Parts condition | Before | After | Before | After | Before | After | Before | After |
| Tensile | 40 | 48 | 45 | 54 | 4 | 5.5 | 8.7 | 11 |
| strength/MPa | | | | | | | | |
| Elongation | 18 | 31 | 38 | 51 | 260 | 400 | 400 | 450 |
| at break/% | | | | | | | | |
| Wear | 58 | 51 | 50 | 41 | 65 | 58 | 59 | 50 |
| loss/mm³ | | | | | | | | |
| Flexural | 1120 | 1050 | 1200 | 1100 | 72 | 65 | 200 | 140 |
| modulus | | | | | | | | |
| at room | | | | | | | | |
| temper- | | | | | | | | |
| ature/MPa | | | | | | | | |
| Surface | 12 | 2.1 | 11 | 2.2 | 14 | 2.2 | 7 | 2.1 |
| roughness | | | | | | | | |
| Ra/μm | | | | | | | | |

TABLE 2
Comparison of mechanical properties of PA12 after surface
smoothing treatment vs. deep enhancement treatment

| | Before | Surface | Deep |
|---|---|---|---|
| Item | treatment | smoothing | enhancement |
| Tensile strength/MPa | 40 | 48 | 54 |
| Elongation at break/% | 18 | 31 | 33 |
| Wear loss/mm³ | 58 | 51 | 49 |
| Flexural modulus at | 1120 | 1050 | 1012 |
| room temperature/MPa | | | |

### Test Methods and Measurement Conditions

Unless otherwise specified, the surface roughness Ra values reported herein were measured using a contact-type mechanical stylus method, in which a stylus mechanically traces the surface profile of the tested part to obtain arithmetic average roughness values. Measurements were conducted at multiple locations on each sample surface, and representative Ra values were obtained based on averaged results.

Wear loss expressed in cubic millimeters (mm³) were determined in accordance with DIN EN ISO 1183-1. The reported wear loss reflect comparative material loss under standardized testing conditions defined by the referenced standard, thereby enabling reliable comparison between untreated and post-processed samples.

### Results and Discussion

As shown in Table 1, after the surface smoothing treatment described herein, the tested 3D-printed plastic parts (PA12, PA11, PEBAX, and TPA) exhibit improvements in one or more mechanical properties, including tensile strength and elongation at break, and reduced surface roughness Ra. In addition, wear loss are reduced after treatment for each material listed in Table 1, indicating improved wear resistance under the reported measurement conditions.

As shown in Table 2, for PA12 parts, the deep enhancement treatment provides a higher tensile strength and a higher elongation at break compared to the surface smoothing treatment, while the room-temperature flexural modulus is further reduced, which indicates increased flexibility of the treated parts. Accordingly, the disclosed post-processing system and methods may be used to address surface roughness and surface-quality limitations commonly observed in 3D-printed plastic parts, and may also improve mechanical performance in a controllable manner.

### Non-Limiting Statement

It will be understood by those skilled in the art that the present disclosure is not limited to the specific embodiments described above. Various modifications, substitutions, and variations may be made without departing from the spirit and scope of the present disclosure. Moreover, although the present specification is described with reference to particular embodiments, the disclosure should be considered as a whole, and technical features described in different embodiments may be combined in suitable ways to form further embodiments that would be understood by those skilled in the art.

1. A post-processing system for 3D-printed plastic parts, comprising:
a solvent storage bottle configured to store a solvent;
a part processing assembly configured to perform vapor polishing on 3D-printed plastic parts; and
a solvent recovery assembly configured to recover solvent vapor generated in the part processing assembly and to re-liquefy and store the recovered solvent,
wherein an output end of the solvent storage bottle is fluidly connected to an input end of a solvent chamber of the part processing assembly through a peristaltic pump, and
wherein the part processing assembly is fluidly connected to the solvent recovery assembly through a recovery valve.

2. The post-processing system according to claim 1, wherein the part processing assembly comprises a reaction chamber,
wherein a hanger configured to suspend the 3D-printed plastic parts is arranged inside the reaction chamber,
wherein a first vacuum pump is connected to the reaction chamber and configured to adjust gas pressure inside the reaction chamber, and
wherein an input end of the reaction chamber is fluidly connected to an output end of the solvent chamber through a pressurizing valve, and an input end of the solvent chamber is connected to the peristaltic pump.

3. The post-processing system according to claim 2, wherein a heating element is arranged at the reaction chamber,
and wherein the heating element comprises a heater configured to heat the reaction chamber.

4. The post-processing system according to claim 3, wherein the solvent recovery assembly comprises a recovery chamber,
wherein an air bag is arranged inside the recovery chamber,
wherein an air inlet valve and an exhaust valve configured to control pressure of the air bag are arranged outside the recovery chamber,
wherein an output end of the recovery chamber is fluidly connected to a condenser tube through a condensing valve, and
wherein an output end of the condenser tube is connected to a recovery bottle.

5. The post-processing system according to claim 4, wherein a second vacuum pump is arranged at the recovery chamber and configured to adjust gas pressure inside the recovery chamber.

6. The post-processing system according to claim 5, wherein the solvent comprises one or more selected from the group consisting of hexafluoroisopropanol, methanol, isopropanol, xylene, para-xylene, acetone, chloroform, and dichloromethane.

7. The post-processing system according to claim 6, wherein the 3D-printed plastic parts comprise plastic parts formed by 3D printing using PA12, PA11, PP, PLA, ABS, PETG, TPU, PEBAX, TPA, or composite materials thereof,
wherein the plastic parts comprise solid parts and/or lattice parts,
wherein a total weight of the 3D-printed plastic parts does not exceed 1000 g, and
wherein a number of the 3D-printed plastic parts ranges from 1 to 50.

8. A processing method based on the post-processing system, comprising the steps of:
(A) mounting 3D-printed plastic parts onto a detachable hanger and placing the hanger into a reaction chamber, sealing the reaction chamber after confirming that the parts do not significantly move and do not contact each other;
(B) setting a solvent type, a solvent amount, a vacuum pressure, a pressure holding time, a drying temperature and time, and a circulating air temperature based on material, weight, quantity, and processing objectives of the 3D-printed plastic parts, and delivering the solvent from a solvent storage bottle into a solvent chamber through a peristaltic pump;
(C) evacuating the reaction chamber to a vacuum state using a first vacuum pump;
(D) opening a pressurizing valve between the reaction chamber and the solvent chamber, such that the solvent chamber rapidly reaches a vacuum state and solvent in the solvent chamber boils and vaporizes, thereby filling the reaction chamber with solvent vapor and uniformly surrounding the parts;
(E) closing the pressurizing valve to allow the solvent vapor to condense into a liquid layer on surfaces of the parts and holding pressure for a predetermined period;
(F) activating a heating element to dry the parts in the reaction chamber, and evacuating a recovery chamber and an air bag therein to a pressure below 0.1 kPa using a second vacuum pump, with an exhaust valve opened and an air inlet valve closed;
(G) closing the second vacuum pump and opening a recovery valve, such that solvent vapor in the reaction chamber rapidly enters the recovery chamber under a pressure differential and liquid solvent on part surfaces accelerates evaporation;
(H) closing the recovery valve and the exhaust valve, opening the air inlet valve and a condensing valve, such that the air bag expands and compresses solvent vapor into a condenser tube, where the solvent vapor is condensed into liquid and collected in a recovery bottle;
(I) closing the condensing valve and the air inlet valve, opening the exhaust valve and the second vacuum pump to evacuate the recovery chamber and the air bag to below 0.1 kPa, thereby entering a next recovery cycle; and
(J) after completion of the recovery cycles, introducing atmospheric air into the reaction chamber, opening an end cover, and removing the parts.

9. The processing method according to claim 8, wherein the vacuum pressure set in step (B) ranges from 0.1 kPa to 20 kPa, and the pressure holding time ranges from 5 to 20 minutes.

10. The processing method according to claim 8, wherein the processing objectives comprise surface smoothing treatment and deep enhancement treatment,
wherein an air temperature during the recovery cycles ranges from 30° C. to 80° C.,
wherein a number of the recovery cycles ranges from 0 to 20,
wherein each recovery cycle has a duration of about 5 minutes,
wherein the drying temperature ranges from 30° C. to 80° C., and
wherein the drying time ranges from 10 to 120 minutes.
